(19) United States
(12) Patent Application Publication
(10) Pub. No.: US 2024/0318031 A1
(43) Pub. Date: Sep. 26, 2024

(54) WATERBORNE ACID-EPOXY COATING COMPOSITION

(71) Applicant: PPG Industries Ohio, Inc., Cleveland, OH (US)

(72) Inventors: Bin Cao, Pittsburgh, PA (US); Qi Zheng, Pittsburgh, PA (US); Michael Allen Mayo, Pittsburgh, PA (US); Matthew Sam Luchansky, Wexford, PA (US); Tsukasa Mizuhara, Seven Valleys, PA (US); Mitchell Ryan Stibbard, Sewickley, PA (US)

(73) Assignee: PPG Industries Ohio, Inc., Cleveland, OH (US)

(21) Appl. No.: 18/259,413

(22) PCT Filed: Dec. 29, 2021
(86) PCT No.: PCT/US2021/065458

§ 371 Date: Jun. 27, 2023

Related U.S. Application Data
(60) Provisional application No. 63/221,145, filed on Jul. 13, 2021.
(60) Provisional application No. 63/131,550, filed on Dec. 29, 2020.

(51) Int. Cl. C09D 163/00; C08G 59/22; C08G 59/24; C08G 59/42; C08G 59/68

(52) U.S. Cl. CPC C09D 163/00; C08G 59/22; C08G 59/24; C08G 59/245; C08G 59/4261; C08G 59/686

(57) ABSTRACT

A two-component waterborne coating system includes: a first component including an acid-functional polymer having an acid value of at least 100, based on total resin solids, dispersed in an aqueous medium; and a second component separate from the first component. The second component includes an epoxy-functional compound. A method of preparing a two-component waterborne coating system and two-component waterborne coating system kit are also described herein.

### FIELD OF THE INVENTION

The present invention relates to a two-component waterborne coating system and a method of preparing the same.

### BACKGROUND OF THE INVENTION

In industrial coating processes, such as those used in vehicle (e.g., automotive) manufacturing, efforts are constantly being made to reduce atmospheric pollution caused by volatile organic compounds (VOCs) which are emitted during a painting process. However, it is often difficult to achieve high quality, smooth coating finishes with adequate physical properties at low VOC levels, such as by using high-solids solventborne coatings and/or powder coatings.

### SUMMARY OF THE INVENTION

The present invention is directed to a two-component waterborne coating system, including: a first component including an acid-functional polymer having an acid value of at least 100, based on total resin solids, dispersed in an aqueous medium; and a second component separate from the first component. The second component includes an epoxy-functional compound.

The present invention is also directed to a method of preparing a two-component waterborne coating system, including: preparing a first component including an acid-functional polymer having an acid value of at least 100, based on total resin solids, dispersed in an aqueous medium; filling a first container with the first component; preparing a second component including an epoxy-functional compound; and filling a second container different from the first container with the second component.

The present invention is also directed to a two-component waterborne coating system kit including: a first container including a first component including an acid-functional polymer having an acid value of at least 100, based on total resin solids, dispersed in an aqueous medium; and a second container separate from the first container, where the second container comprises a second component including an epoxy-functional compound.

### BRIEF DESCRIPTION OF THE DRAWINGS

FIG. 1 shows a coating system including a first component and a separate second component; and

FIG. 2 shows a mixing container including a coating composition formed by contacting amounts of the first component and the second component.

### DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and the plural encompasses the singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” crosslinker, “an” epoxy compound, and the like refer to one or more of any of these items.

As used herein, a “film-forming resin” refers to a self-supporting continuous film on at least a horizontal surface of a substrate upon removal of any diluents or carriers present in the composition or upon curing. Also, as used herein, the term “polymer” is meant to refer to prepolymers, oligomers, and both homopolymers and copolymers. The term “resin” is used interchangeably with “polymer”.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the invention.

The present invention is directed to a two-component waterborne coating system including a first and second component. The first component includes an acid-functional polymer having an acid value of at least 100, based on total resin solids, dispersed in an aqueous medium. The second component includes an epoxy-functional compound, and the second component is separate from the first component.

The first component includes an acid-functional polymer dispersed in an aqueous medium.

As used herein, an “aqueous medium” refers to a liquid medium comprising at least 50 weight % water, based on the total weight of the liquid medium. Such aqueous liquid mediums can for example comprise at least 60 weight % water, or at least 70 weight % water, or at least 80 weight % water, or at least 90 weight % water, or at least 95 weight % water, or 100 weight % water, based on the total weight of the liquid medium. The solvents that, if present, make up less than 50 weight % of the liquid medium include organic solvents. Non-limiting examples of suitable organic solvents include polar organic solvents, e.g. protic organic solvents such as glycols, glycol ether alcohols, alcohols, volatile ketones, glycol diethers, esters, and diesters. Other non-limiting examples of organic solvents include aromatic and aliphatic hydrocarbons. A “waterborne coating composition” refers to a coating composition comprising an aqueous medium.

The acid-functional polymer has an acid value of at least 100, such as at least 130, at least 140, or at least 170, based on total resin solids. Acid value, as referred to herein, is measured using a Metrohm 798 MPT Titrino automatic titrator according to ASTM D1639.

The acid-functional polymer may comprise an acrylic polymer. The acrylic polymer may comprise an addition polymer formed from ethylenically unsaturated monomers, and suitable ethylenically unsaturated groups include, but are not limited to, (meth)acrylate groups, vinyl groups, or a combination thereof. As used herein, the term “(meth)acrylate” refers to both the methacrylate and the acrylate. Suitable acid group containing unsaturated monomers that may be used to form the acid-functional polymer include, but are not limited to, (meth)acrylic acid, itaconic acid, maleic acid, fumaric acid, crotonic acid, anhydrides thereof or a combination thereof. The acid-functional acrylic polymer may be formed from a hydroxyl-containing acrylic monomer, an acrylic monomer different from the hydroxyl-containing acrylic monomer, and an anhydride. The acid-functional acrylic polymer may be formed by reacting the acrylic monomers and then post-reacting the product with anhydride to generate the acid functional acrylic polymer. The acid-functional acrylic polymer may be formed by mixing the acrylic monomers with the anhydride together so as to polymerize and ring-open together to generate the acid functional acrylic polymer. The acid-functional acrylic polymer may be formed by pre-reacting the hydroxyl-containing acrylic monomer with the anhydride to form a pre-monomer half-acid ester (e.g., hydroxyl ethyl acrylate could be reacted with hexahydrophthalic anhydride under mild reaction conditions to produce the half-acid ester which would contain one C═C group and one COOH group). This could then be formed into the acid-functional acrylic polymer via additional polymerization using the C═C group by reacting the pre-monomer with the acrylic monomer different from the hydroxyl-containing acrylic monomer to generate the acid functional acrylic polymer.

The acid-functional polymer may have a weight average molecular weight (Mw) of at least 2,000, such as at least 2,500, at least 3,000, or at least 3,500. The acid-functional polymer may have an Mw of up to 20,000, such as up to 15,000, up to 10,000, or up to 5,000. The acid-functional polymer may have an Mw of from 2,000 to 20,000, such as from 2,000 to 15,000, from 2,000 to 10,000, from 2,000 to 5,000, from 3,500 to 20,000, from 3,500 to 15,000, from 3,500 to 10,000, or from 3,500 to 6,500.

Mw and number average molecular weight (Mn), as reported herein, are measured by gel permeation chromatography using a polystyrene standard according to ASTM D6579-11 performed using a Waters 2695 separation module with a Waters 2414 differential refractometer (RI detector); tetrahydrofuran (THF) was used as the eluent at a flow rate of 1 ml/min, and two PLgel Mixed-C (300×7.5 mm) columns were used for separation at the room temperature; weight and number average molecular weight of polymeric samples can be measured by gel permeation chromatography relative to linear polystyrene standards of 800 to 900,000 Da).

The acid-functional polymer may have a Tg of from −40° C. to 80° C., such as from 20° C. to 80° C., from 20° C. to 60° C., or from 25° C. to 50° C. Tg, as reported herein, is calculated according to the Fox Equation unless otherwise indicated.

The two-component coating system may comprise from 20 to 90 weight % of the acid-functional polymer, such as from 25 to 80 weight %, from 20 to 75 weight %, or from 23 to 72 weight %, based on total resin solids of the coating system. The two-component coating system may comprise at least 20 weight % of the acid functional polymer, such as at least 25 weight %, at least 30 weight %, at least 40 weight %, or at least 50 weight %, based on total resin solids of the coating system. The two-component coating system may comprise up to 90 weight % of the acid functional polymer, such as up to 85 weight %, up to 80 weight %, up to 75 weight %, or up to 70 weight %, based on total resin solids of the coating system.

The acid-functional polymer and/or the first component may be prepared in a continuous stirred-tank reactor (CSTR) to allow for formation of the acid-functional polymer at a higher solids, to minimize the amount of solvent needed during synthesis (e.g., lower VOCs), and/or to simplify the synthesis procedure (e.g., eliminating a solvent stripping step). The acid-functional polymer and/or the first component may be prepared in a batch reactor.

The acid functional polymer as the first component may be prepared as an acrylic polymer using a CSTR. The acrylic polymer may be formed from a hydroxyl-containing acrylic monomer, an acrylic monomer different from the hydroxyl-containing acrylic monomer, and an anhydride. The acrylic polymer may be formed by reacting the acrylic monomers in the CSTR and then post-reacting the product with anhydride to generate the acid functional acrylic polymer. The acrylic polymer may be formed by mixing and co-feeding the acrylic monomers with the anhydride into the CSTR together so as to polymerize and ring-open together in the CSTR to generate the acid functional acrylic polymer. The acrylic polymer may be formed by pre-reacting the hydroxyl-containing acrylic monomer with the anhydride to form a pre-monomer half-acid ester (e.g., hydroxyl ethyl acrylate could be reacted with hexahydrophthalic anhydride under mild reaction conditions to produce the half-acid ester which would contain one C═C group and one COOH group). This could then be formed into the acid-functional acrylic polymer via additional polymerization using the C═C group by reacting the pre-monomer with the acrylic monomer different from the hydroxyl-containing acrylic monomer in the CSTR to generate the acid functional acrylic polymer.

The first component may be substantially free of the epoxy-functional compound described in connection with the second component (less than 5 weight % of the epoxy-functional compound based on total weight of components in the first component). The first component may be essentially free of the epoxy-functional compound (less than 1 weight % of the epoxy-functional compound based on total weight of components in the first component). The first component may be free of the epoxy-functional compound (0 weight % of the epoxy-functional compound based on total weight of components in the first component).

The second component includes an epoxy-functional compound.

The epoxy-functional compound may have an Mw of up to 2,000, such as up to 1,500, up to 1,000, up to 750, up to 500, or up to 400. The epoxy-functional compound may have an Mw of from 180 to 2,000, such as from 180 to 1,000, from 180 to 750, from 180 to 500, from 180 to 400, or from 200 to 350.

The epoxy-functional compound may include a cycloaliphatic epoxy, an aliphatic epoxy, a hexahydrophthalic anhydride-based diester epoxy, a cyclohexane dimethanol-based epoxy, a neopentyl glycol-based epoxy, a polyglycidyl ether epoxy (e.g., 1,4-butanediol diglycidyl ether), an aromatic polyfunctional epoxy, a bisphenol-A bisepoxide, a hydrogenated bisphenol-A bisepoxide, a triglycidyl ether of trimethylolpropane, a Novolac epoxy, or some combination thereof. The epoxy-functional compound may comprise at least two epoxy groups, such as at least three epoxy groups.

The two-component coating system may comprise from 8 to 70 weight % of the epoxy-functional compound, such as from 10 to 70 weight %, from 10 to 60 weight %, from 8 to 60 weight %, from 15 to 50 weight %, or from 20 to 40 weight %, based on total resin solids of the coating system. The two-component coating system may comprise at least 8 weight % of the epoxy-functional compound, such as at least 10 weight %, at least 15 weight %, or at least 20 weight %, based on total resin solids of the coating system. The two-component coating system may comprise up to 70 weight % of the epoxy-functional compound, such as up to 65 weight %, up to 60 weight %, or up to 55 weight %, based on total resin solids of the coating system.

The second component may additionally include a second epoxy-functional compound different from (having a different chemical structure and/or prepared from different monomers and/or monomer amounts) the above-listed epoxy-functional compounds. The second epoxy-functional compound may be included in the second component in a lower amount compared to the above-listed epoxy-functional compound. The two-component coating system may comprise up to 50 weight % of the second epoxy-functional compound, such as up to 40 weight %, up to 30 weight %, up to 20 weight %, up to 10 weight %, or up to 5 weight %, based on total resin solids of epoxy resins in the coating system. The second epoxy-functional compound may comprise an epoxy-functional acrylic, such as a glycidyl methacrylate-based epoxy. The second epoxy-functional compound may comprise a castor oil-based epoxy. The second epoxy-functional compound may comprise a polyurethane-based epoxy, such as a polyurethane epoxy dispersion. In alternative examples, the coating system may be substantially free (less than 3 weight % based on total resin solids of the coating system), essentially free (less than 1 weight % based on total resin solids of the coating system), or free (0 weight % based on total resin solids of the coating system) of the second epoxy-functional compound.

The second component may be substantially free of water (less than 5 weight % water based on total weight of components in the second component). The second component may be essentially free of water (less than 1 weight % water based on total weight of components in the second component). The second component may be free of water (0 weight % water based on total weight of components in the second component).

The second component may be substantially free of the acid-functional polymer described in connection with the first component (less than 5 weight % of the acid-functional polymer based on total weight of components in the second component). The second component may be essentially free of the acid-functional polymer (less than 1 weight % of the acid-functional polymer based on total weight of components in the second component). The second component may be free of the acid-functional polymer (0 weight % of the acid-functional polymer based on total weight of components in the second component).

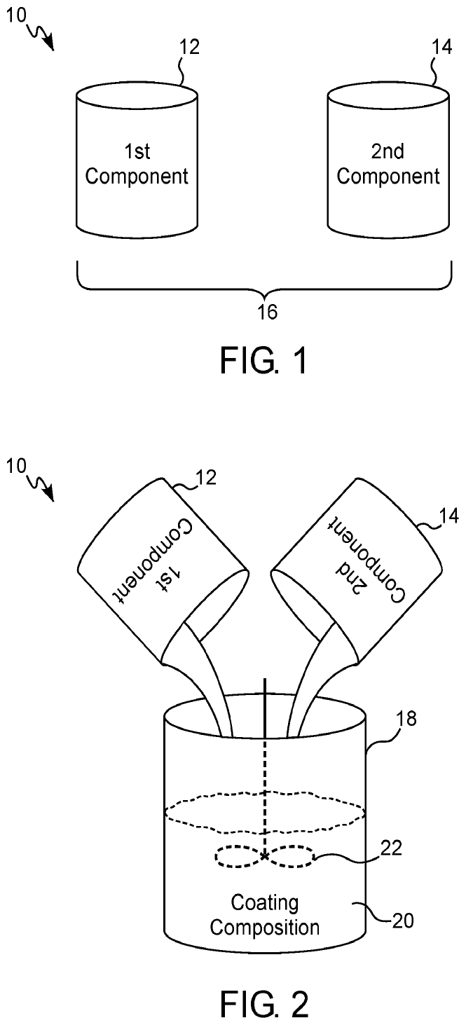

The second component is separate from the first component, as shown in FIG. 1. Referring to FIG. 1, a coating system 10 is shown which includes the first component 12 and the second component 14. The first and second components 12, 14 may be stored in separate containers (also referred to herein as “packs”) prior to mixing, such as until a user is ready to apply the coating composition formed from the coating system 10 to a substrate. As such, the first and second components 12, 14 may not be in contact with one another until the user is ready to apply the coating composition formed from the coating system 10. In addition, FIG. 1 shows a kit 16 including the coating system 10, wherein the kit includes the first component 12 in a first container and the second component 14 in a separate second container. The second container may be substantially free of water. The second component 14 may not be in contact with the first component 12 in the kit 16.

Referring to FIG. 2, a mixing container 18 including a coating composition 20 is shown. The coating composition 20 is formed by contacting amounts of the first component 12 and the second component 14, such as by combining at least a portion of the contents of the separate first and second containers into the mixing container 18. The first and second components 12, 14 may be combined in a predetermined ratio or at a predetermined stoichiometric ratio of reactive functional groups on a component of the first and second components 12, 14 to form the coating composition 20. The ratio of acid groups to epoxy groups in the coating system (e.g., from the acid-functional polymer and the epoxy-functional compound, respectively) may range from 1.5:1 to 1:1.5, such as from 1.2:1 to 0.9:1 or from 1.1:1 to 1:1.1. The ratio of acid groups to epoxy groups in the coating system may be greater than or equal to 1:1. The coating system may include acid groups in excess of epoxy groups. A mixer 22 may mix the added first and second components 12, 14, which form the coating composition 20 to form a homogenous mixture thereof.

With continued reference to FIG. 2, the mixer 22 may comprise an in-line mixing device, such as an in-line two component mixing device. By such a device, each component may be pumped from their individual container through tubing or piping to a point where they are mixed together in the in-line mixing device and subsequently delivered to the coating composition applicator (not shown), such as a spray gun, bell atomizer, and the like.

With continued reference to FIG. 2, upon contacting the first and second components 12, 14 to form the coating composition 20, the coating composition 20 may be applied to a substrate as described hereinafter. The coating composition 20 may begin to cure and/or harden upon mixing the first and second components 12, 14. The coating composition 20 may be cured into a coating at ambient temperature (20° C.-27° C., e.g., 23° C.) within 48 hours of first contacting the first component 12 with the second component 14, such as within 24 hours, within 12 hours, or within 8 hours. The coating composition 20 may double in viscosity at ambient temperature within 48 hours of first contacting the first component 12 with the second component 14, such as within 24 hours, within 12 hours, or within 8 hours. Viscosity is determined herein with a Brookfield CAP 2000 Viscometer using a #4 spindle at 300 rpm at 23° C. As viscosity increases above a certain threshold, its suitability for application, such as by spraying, brushing, rolling, and the like, may decrease. The coating composition 20 may no longer be applicable (e.g., sprayable, brushable, rollable, etc.) within 48 hours of first contacting the first component 12 with the second component 14, such as within 24 hours, within 12 hours, or within 8 hours.

The coating system may comprise additional materials (additional to the acid-functional polymer and the epoxy-functional compound) as described hereinafter, such as a neutralizing amine, a catalyst, a crosslinker, an additional resin, a pigment, and other such suitable materials and combinations of materials. The additional materials may be contained in the first component 12 and/or the second component 14. The coating system may comprise additional components beyond the first and second components 12, 14, such as a third component (not shown), a fourth component (not shown), and the like. The additional components may contain at least a portion of the additional materials.

The coating system may further include a neutralizing amine to at least partially neutralize the acid-functional polymer to form a salt. Suitable neutralizing amines include ammonium hydroxide, dimethylamine, trimethylamine, triethylamine, monoethanolamine, diisopropanolamine, diethanolamine, dimethylethanolamine, or a combination thereof.

The neutralizing amine may be included in the first component. The neutralizing amine may be included in the second component. The neutralizing amine may be included in the first and second components, and the first and second components may include the same or different neutralizing amine.

The acid-functional polymer may be at least 15% neutralized using the neutralizing amine, such as at least 20% neutralized, at least 25% neutralized, or at least 30% neutralized. The acid functional polymer may be up to 120% neutralized using the neutralizing amine, such as up to 100% neutralized, up to 80% neutralized, up to 60% neutralized, or up to 50% neutralized. The acid-functional polymer may be from 15% to 120% neutralized using the neutralizing amine, such as from 15% to 100% neutralized, from 15% to 80% neutralized, from 15% to 60% neutralized, from 15% to 50% neutralized, from 15% to 45% neutralized, from 15% to 40% neutralized, or from 15% to 35% neutralized. Neutralization of the acid-functional polymer (total neutralization percent) may be theoretically determined based on the equivalence of the amine (of the neutralizing amine) divided by the equivalence of the acid (of the acid-functional polymer). A neutralization of the acid-functional polymer within this range may result in a balance of a sufficiently stable polymer for inclusion in a clearcoat composition (increases in neutralization result in a more stable resin) while maintaining a sufficiently low viscosity to function as a flowable coating composition capable of application to a substrate, such as by spraying or other application methods described hereinafter (increases in neutralization result in a more viscous resin).

The coating system may further include a catalyst. The catalyst may also function as the neutralizing amine. Alternatively, the catalyst may be different from the neutralizing amine. The catalyst may be included in the first component. The catalyst may be included in the second component. The catalyst may be included in the first and second components, and the first and second components may include the same or different catalyst.

The catalyst may accelerate the cure of the epoxy and acid groups. Examples of suitable catalysts include organic amines and quaternary ammonium compounds such as pyridine, piperidine, dimethylaniline, diethylenetriamine, 1,4-diazabicyclo[2.2.2]octane (DABCO), tetramethyl ammonium chloride, tetramethyl ammonium acetate, and tetramethyl benzyl ammonium acetate. The amount of catalyst may range from 0 to 10 weight %, such as 0.5 to 5 weight % or 0.5 to 3 weight %, based on total resin solids of the coating system. The organic amine may comprise a tertiary amine.

The coating system may further include a crosslinker. The crosslinker may be included in the first component. The crosslinker may be included in the second component. The crosslinker may be included in the first and second components, and the first and second components may include the same or different crosslinker.

The crosslinker may comprise an aminoplast (e.g., a melamine), a blocked isocyanate, a silane, an oxazoline, a carbodiimide, or some combination thereof.

The aminoplast crosslinker may include melamine. The aminoplast crosslinker may include condensates of amines and/or amides with aldehyde. The aminoplast crosslinker may be reactive with secondary hydroxyl groups formed from the reaction of epoxy and carboxylic acid groups in the coating composition, or hydroxyl groups that may be present on the acid-functional polymer or the epoxy-functional compound to crosslink the system. The aminoplast crosslinker may also self-condense to self-crosslink. The aminoplast crosslinker may be a component of the first component, the second component, or both the first and second components. Non-limiting examples of aminoplast crosslinkers include RESIMENE 717, RESIMENE 718, and RESIMENE HM 2608 (all available from Prefere Resins (Erkner, Germany)) or CYMEL 200, and CYMEL 1158 (both available from Allnex (Alpharetta, Georgia)).

The blocked isocyanate crosslinker may be reactive with secondary hydroxyl groups formed from the reaction of epoxy and carboxylic acid groups in the coating composition, or hydroxyl groups that may be present on the acid-functional polymer or the epoxy-functional compound to crosslink the system. The blocked isocyanate crosslinker may be a component of the first component, the second component, or both the first and second components. Non-limiting examples of blocked isocyanate crosslinkers that may be included as a component of the first component include VESTANAT EP-DS1205E (a trimer of isophoronediisocyanate (IPDI) blocked with methylketoxime, supplied in water/solvent mix available from Evonik Industries (Essen, Germany)) and BAYHYTHERM 3246/1 (a hexamethylene diisocyanate (HDI) based and blocked with dimethyl pyrazole, supplied in water/solvent mix available from Covestro (Leverkusen, Germany)). A non-limiting example of a blocked isocyanate crosslinker that may be included as a component of the second component includes VESTANAT B1042E (a trimer of IPDI blocked with diethyl malonate available from Evonik Industries (Essen, Germany)). Non-limiting examples of blocked isocyanate crosslinkers that may be included as a component of the first and/or second component include DESMODUR BL3175 (a HDI based and blocked with methylketoxime, supplied in solvent) or DESMODUR PL350 (a HDI based and blocked with dimethyl pyrazole, supplied in solvent) (both available from Covestro (Leverkusen, Germany)) and VESTANAT B135BA (an IPDI trimer and blocked with methylketoxime, supplied in solvent) or VESTANAT B1186A (an IPDI trimer and blocked with E-caprolactam, supplied in solvent) (both available from Evonik Industries (Essen, Germany)).

The silane crosslinker may self-condense to form self-crosslinks around the other binder resins. The silane crosslinker may react with hydroxyl groups formed from the reaction of epoxy and carboxylic acid groups in the coating composition, or hydroxyl groups that may be present on the acid-functional polymer or the epoxy-functional compound to crosslink the system. The silane crosslinker may be a component of the first component, and non-limiting examples of silane crosslinkers that may be a component of the first component include SILQUEST A-189 (a gamma-mercaptopropyltrimethoxysilane) and SILQUEST A-1170 (bis-gamma-trimethoxysilylpropylamine) (both available from Momentive Performance Materials (Waterford, NY)). The silane crosslinker may be a component of the second component, and non-limiting examples of silane crosslinkers that may be a component of the second component include SILQUEST A-186 (3,4-Epoxycyclohexyl)ethyltrimethoxysilane), SILQUEST A-187 (gamma-glycidoxypropyltrimethoxysilane), and COATOSIL MP-200 (Epoxy functional silane oligomer) (all available from Momentive Performance Materials (Waterford, NY)).

The oxazoline crosslinker may be reactive with carboxylic acid groups to crosslink the system. The oxazoline crosslinker may comprise an aqueous dispersion. The oxazoline crosslinker may be a component of the first component. Non-limiting examples of oxazoline crosslinkers that may be a component of the first component comprise EPOCROS K-2010E, K-2020E, K-2030E, WS-300, WS-500, and WS-700 (all available from Nippon Shokubai Co., Ltd. (Tokyo, Japan)).

The carbodiimide crosslinker may be reactive with carboxylic acid groups to crosslink the system. The carbodiimide crosslinker may contain no solvent or water and be included as a component of the second component. Non-limiting examples of such carbodiimide crosslinkers that may be a component of the second component comprise PICASSIAN XL-725, XL-755, and XL-762 (all available from Stahl (Waalwijk, Netherlands)).

The coating system may include an additional resin different from the acid-functional polymer and epoxy-functional compound previously described. The additional resin may be included in the first component. The additional resin may be included in the second component. The additional resin may be included in the first and second components, and the first and second components may include the same or different additional resins.

The additional resin may include a film-forming resin. The additional resin may include any of a variety of thermoplastic and/or thermosetting film-forming resins known in the art. The term “thermosetting” refers to resins that “set” upon curing or crosslinking, wherein the polymer chains of the resins are joined together by covalent bonds. Once cured or crosslinked, a thermosetting resin will not melt upon the application of heat and is insoluble in solvents. As noted, the film-forming resin can also include a thermoplastic film-forming resin. The term “thermoplastic” refers to resins that are not joined by covalent bonds and, thereby, can undergo liquid flow upon heating and can be soluble in certain solvents.

Suitable additional resins include polyurethanes, polyesters (e.g., polyester polyols), polyamides, polyethers, polysiloxanes, fluoropolymers, polysulfides, polythioethers, polyureas, (meth)acrylic resins (other than those previously described), epoxy resins (other than those previously described), vinyl resins, copolymers thereof, and mixtures thereof. The additional resin may include a grind resin used to introduce pigment into the coating system.

The additional resin can have any of a variety of reactive functional groups including, but not limited to, carboxylic acid groups, amine groups, epoxide groups, hydroxyl groups, thiol groups, carbamate groups, amide groups, urea groups, isocyanate groups (including blocked isocyanate groups), (meth)acrylate groups, and combinations thereof. Blocked isocyanate and/or melamine resin may be added as an additional resin to the coating system to increase crosslink density of the coating system. Thermosetting coating compositions typically comprise a crosslinker that may be selected from any of the crosslinkers known in the art to react with the functionality of the resins used in the coating systems. Alternatively, a thermosetting film-forming resin can be used having functional groups that are reactive with themselves; in this manner, such thermosetting resins are self-crosslinking.

The coating composition may include from 0 to 20 weight %, such as from 2.5 to 20 weight %, from 2.5 to 15 weight %, from 2.5 to 10 weight %, from 5 to 20 weight %, from 5 to 15 weight %, 5 to 10 weight %, from 10 to 20 weight %, or from 15 to 20 weight %, of the additional resin based on total resin solids of the coating system. The coating composition may include at least 2.5 weight % or at least 5 weight % or at least 10 weight % of the additional resin (if included) based on total resin solids of the coating system. The coating composition may include up to 20 weight % or up to 15 weight % of the additional resin (if included) based on total resin solids of the coating system.

The coating system may also include additional materials, such as a pigment. The pigment may be included in the first component. The pigment may be included in the second component. The pigment may be included in the first and second components, and the first and second components may include the same or different pigment.

The pigment may include a finely divided solid powder that is insoluble, but wettable, under the conditions of use. The pigment may have an average particle size of up to 50 microns, such as up to 25 microns, up to 10 microns, up to 5 microns, or up to 2 microns. Average particle size may be determined by known light scattering techniques. For example the average particle size of such particles may be measured using a Malvern Zetasizer. The pigment can be organic or inorganic and can be agglomerated or non-agglomerated. Pigments can be incorporated into the coating system by use of a grind vehicle, such as an acrylic grind vehicle, the use of which will be familiar to one skilled in the art. The acid-functional polymer and/or the epoxy-functional compound may function as the grind vehicle.

Suitable pigments and/or pigment compositions include, but are not limited to, carbazole dioxazine crude pigment, azo, monoazo, diazo, naphthol AS, salt type (flakes), benzimidazolone, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, and mixtures thereof.

The pigment used with the coating system can also comprise a special effect pigment. As used herein, a “special effect pigment” refers to a pigment that interacts with visible light to provide an appearance effect other than, or in addition to, a continuous unchanging color. Suitable special effect pigments include those that produce one or more appearance effects such as reflectance, pearlescence, metallic sheen, texture, phosphorescence, fluorescence, photochromism, photosensitivity, thermochromism, goniochromism, and/or color-change, such as transparent coated mica and/or synthetic mica, coated silica, coated alumina, aluminum flakes, a transparent liquid crystal pigment, a liquid crystal coating, or a combination thereof.

The coating system may form a clearcoat which comprises up to 15 weight % of pigment, based on total solids of the coating system, such as up to 12 weight %, up to 10 weight %, or up to 5 weight %. The coating system may comprise from 0 to 15 weight % of pigment, based on total solids of the coating system, such as from 2 to 10 weight % or from 1 to 10 weight %. In some examples, the coating system may form a clearcoat substantially free of a pigment. Substantially free of a pigment may mean that the coating system comprises less than 3 weight % of pigment, based on total solids of the coating system, such as less than 2 weight %, less than 1 weight %, or 0 weight %.

Other suitable materials that can be used with the coating system include, but are not limited to, plasticizers, abrasion resistant particles, anti-oxidants, hindered amine light stabilizers, UV light absorbers and stabilizers, surfactants, flow and surface control agents, thixotropic agents, reaction inhibitors, and other customary auxiliaries. These materials may be included in the first component. These materials may be included in the second component. These materials may be included in the first and second components, and the first and second components may include the same or different of these materials. For example, the first component may contain a first subset of additional materials and the second component may contain a second subset of additional materials, wherein the first and/or second subset include at least one different additional material.

The coating system may be substantially free (less than 5 weight % based on total solids of the coating system) of unreacted isocyanate (e.g., at ambient temperatures). The coating composition may be essentially free (less than 1 weight % based on total solids of the coating system) of unreacted isocyanate. The coating composition may be free (0 weight % based on total solids of the coating system) of unreacted isocyanate. As used herein, “unreacted isocyanate” refers to a molecule having at least one —N═C═O group at ambient temperature. The blocked isocyanate described herein does not constitute “unreacted isocyanate” because at ambient temperatures it includes an isocyanate reaction product (isocyanate reacted with blocking group) that is stable at room temperature, and its isocyanate functionality regenerates when its blocking group is released at elevated temperatures.

The coating system may have a volatile organic content (VOC) below 420 g/L, such as below 400 g/L, below 350 g/L, or below 300 g/L, based on total volume of the coating system. VOC is measured herein excluding water and according to ASTM D3960. The measured VOC refers to the VOC of the coating composition ready to be applied to the substrate (such that no additional components need to be added prior to application of the coating composition that may increase the reported VOC of the coating system).

The coating system may be applied to a substrate and cured to form a coating thereover by contacting the first component and the second component (from their separate containers) to form a coating composition and applying the formed coating composition over the substrate prior to full curing of the coating composition (e.g., within 48, 24, 12, or 8 hours of first contacting the first and second components). The coating may be a continuous film formed over at least a portion the substrate.

The coating system may be curable at temperature below 140° C., such as below 130° C., such as 127° C. As used herein, “curable” at a prescribed temperature means that the cured coating layer, formed when the first and second component are contacted and applied to form a coating layer having a thickness of from 5 to 100 μm and baked at the prescribed temperature for 30 minutes, achieves at least 75 MEK double rubs as measured according to ASTM D5402-15.

The substrate over which the coating composition formed from the coating system may be applied includes a wide range of substrates. For example, the coating composition of the present invention can be applied to a vehicle substrate, an industrial substrate, an aerospace substrate, and the like.

The vehicle substrate may include a component of a vehicle. In the present disclosure, the term “vehicle” is used in its broadest sense and includes all types of aircraft, spacecraft, watercraft, and ground vehicles. For example, the vehicle can include, but is not limited to an aerospace substrate (a component of an aerospace vehicle, such as an aircraft such as, for example, airplanes (e.g., private airplanes, and small, medium, or large commercial passenger, freight, and military airplanes), helicopters (e.g., private, commercial, and military helicopters), aerospace vehicles (e.g., rockets and other spacecraft), and the like). The vehicle can also include aground vehicle such as, for example, animal trailers (e.g., horse trailers), all-terrain vehicles (ATVs), cars, trucks, buses, vans, heavy duty equipment, tractors, golf carts, motorcycles, bicycles, snowmobiles, trains, railroad cars, and the like. The vehicle can also include watercraft such as, for example, ships, boats, hovercrafts, and the like. The vehicle substrate may include a component of the body of the vehicle, such as an automotive hood, door, trunk, roof, and the like; such as an aircraft or spacecraft wing, fuselage, and the like; such as a watercraft hull, and the like.

The coating composition may be applied over an industrial substrate which may include tools, heavy duty equipment, furniture such as office furniture (e.g., office chairs, desks, filing cabinets, and the like), appliances such as refrigerators, ovens and ranges, dishwashers, microwaves, washing machines, dryers, small appliances (e.g., coffee makers, slow cookers, pressure cookers, blenders, etc.), metallic hardware, extruded metal such as extruded aluminum used in window framing, other indoor and outdoor metallic building materials, and the like.

The coating composition may be applied over storage tanks, windmills, nuclear plant components, packaging substrates, wood flooring and furniture, apparel, electronics, including housings and circuit boards, glass and transparencies, sports equipment, including golf balls, stadiums, buildings, bridges, and the like.

The substrate can be metallic or non-metallic. Metallic substrates include, but are not limited to, tin, steel (including electrogalvanized steel, cold rolled steel, hot-dipped galvanized steel, among others), aluminum, aluminum alloys, zinc-aluminum alloys, steel coated with a zinc-aluminum alloy, and aluminum plated steel. Non-metallic substrates include polymeric materials, plastic and/or composite material, polyester, polyolefin, polyamide, cellulosic, polystyrene, polyacrylic, poly(ethylene naphthalate), polypropylene, polyethylene, nylon, ethylene vinyl alcohol (EVOH), polylactic acid, other “green” polymeric substrates, poly(ethyleneterephthalate) (PET), polycarbonate, polycarbonate acrylobutadiene styrene (PC/ABS), wood, veneer, wood composite, particle board, medium density fiberboard, cement, stone, glass, paper, cardboard, textiles, leather, both synthetic and natural, and the like. The substrate may comprise a metal, a plastic and/or composite material, and/or a fibrous material. The fibrous material may comprise a nylon and/or a thermoplastic polyolefin material with continuous strands or chopped carbon fiber. The substrate can be one that has already been treated in some manner, such as to impart visual and/or color effect, a protective pretreatment or other coating layer, and the like.

The coating composition formed from the coating system of the present invention may be particularly beneficial when applied to a metallic substrate. The coatings of the present invention may be particularly beneficial when applied to metallic substrates that are used to fabricate automotive vehicles, such as cars, trucks, and tractors.

The coating composition formed from the coating system may be applied to a substrate having multiple components, wherein the coating composition is simultaneously applied to the multiple components and simultaneously cured to form a coating over the multiple components without deforming, distorting, or otherwise degrading any of the components. The components may be parts of a larger whole of the substrate. The components may be separately formed and subsequently arranged together to form the substrate. The components may be integrally formed to form the substrate.

Non-limiting examples of components of a substrate in the vehicle context include a vehicle body (e.g., made of metal) and a vehicle bumper (e.g., made or plastic) which are separately formed and subsequently arranged to form the substrate of the vehicle. Further examples include a plastic automotive component, such as a bumper or fascia in which the bumper or fascia comprises regions or subcomponents which comprise more than one type of substrate. Further examples include aerospace or industrial components comprising more than one substrate type. It will be appreciated that other such other multi-component substrates are contemplated within the context of this disclosure.

The multiple components may include at least a first component and a second component, and the first component and the second component may be formed from different materials. As used herein, “different materials” refers to the materials used to form the first and second component having different chemical make-ups.

The different materials may be from the same or different class of materials. As used herein, a “class of materials” refers to materials that may have a different specific chemical make-up but share the same or similar physical or chemical properties. For example, metals, polymers, ceramics, and composites may be defined as different classes of materials. However, other classes of materials may be defined depending on similarities in physical or chemical properties, such as nanomaterials, biomaterials, semiconductors, and the like. Classes of materials may include crystalline, semi-crystalline, and amorphous materials. Classes of materials, such as for polymers, may include thermosets, thermoplastics, elastomers, and the like. Classes of materials, such as for metals, may include alloys and non-alloys. As will be appreciated from the above exemplary list of classes, other relevant classes of materials may be defined based on a given physical or chemical property of materials.

The first component may be formed from a metal, and the second component may be formed from a plastic or a composite. The first component may be formed from a plastic, and the second component may be formed from a metal or a composite. The first component may be formed from a composite, and the second component may be formed from a plastic or a metal. The first component may be formed from a first metal, and the second component may be formed from a second metal different from the first metal. The first component may be formed from a first plastic, and the second component may be formed from a second plastic different from the first plastic. The first component may be formed from a first composite, and the second component may be formed from a second composite different from the first composite. As will be appreciated from these non-limiting examples, any combination of different materials from the same or different classes may form the first and second components of the substrate.

Examples of combinations of materials include thermoplastic polyolefins (TPO) and metal, TPO and acrylonitrile butadiene styrene (ABS), TPO and acrylonitrile butadiene styrene/polycarbonate blend (ABS/PC), polypropylene and TPO, TPO and a fiber reinforced composite, and other combinations. Further examples include aerospace substrates or industrial substrates comprising various components made of a plurality of materials, such as various metal-plastic, metal-composite, and/or plastic-composite containing components. The metals may include ferrous metals and/or non-ferrous metals. Non-limiting examples of non-ferrous metals include aluminum, copper, magnesium, zinc, and the like, and alloys including at least one of these metals. Non-limiting examples of ferrous metals include iron, steel, and alloys thereof.

When the coating composition is applied to the substrate having multiple components simultaneously, the applied coating composition may be cured at a temperature which does not deform, distort, or otherwise degrade either of the first and second component (the materials thereof). Thus, the curing temperature may be below the temperature at which either of the first component or the second component of the substrate would deform, distort, or otherwise degrade.

The coating composition formed from the coating system may be applied to the substrate by any suitable means, such as spraying, electrostatic spraying, dipping, rolling, brushing, and the like.

The coating composition formed from the coating system can be applied to a substrate to form a pigmented topcoat. The pigmented topcoat may be the topmost coating layer so as not to include a clearcoat or any other coating layer thereover. The pigmented topcoat may be applied directly to the substrate. The pigmented topcoat may be applied over a primer layer or a pretreatment layer.

The coating composition formed from the coating system can be applied to a substrate as a coating layer of a multi-layer coating system, such that one or more additional coating layers are formed below and/or above the coating formed from the coating composition.

The coating composition formed from the coating system can be applied to a substrate as a primer coating layer of the multi-layer coating system. A “primer coating layer” refers to an undercoating that may be deposited onto a substrate (e.g., directly or over a pretreatment layer) in order to prepare the surface for application of a protective or decorative coating system.

The coating composition formed from the coating system can be applied to a substrate as a basecoat layer of the multi-layer coating system. A “basecoat” refers to a coating that is deposited onto a primer overlying a substrate and/or directly onto a substrate, optionally including components (such as pigments) that impact the color and/or provide other visual impact. A clearcoat may be applied over the basecoat layer.

The coating composition formed from the coating system can be applied to a substrate as a topcoat layer of the multi-layer coating system. A “topcoat” refers to an uppermost coating that is deposited over another coating layer, such as a basecoat, to provide a protective and/or decorative layer, such as the previously described pigmented topcoat.

The topcoat layer used with the multi-layer coating system may be a clearcoat layer, such as a clearcoat layer applied over a basecoat layer. As used herein, a “clearcoat” refers to a coating layer that is at least substantially transparent or fully transparent. The term “substantially transparent” refers to a coating, wherein a surface beyond the coating is at least partially visible to the naked eye when viewed through the coating. The term “fully transparent” refers to a coating, wherein a surface beyond the coating is completely visible to the naked eye when viewed through the coating. It is appreciated that the clearcoat can comprise colorants, such as pigments, provided that the colorants do not interfere with the desired transparency of the clearcoat. The clearcoat can be substantially free or free of pigments.

The coating composition formed from the coating system may be applied over a substrate as a layer in a multi-layer coating system. In the multi-layer coating system, a first basecoat layer may be applied over at least a portion of a substrate, wherein the first basecoat layer is formed from a first basecoat composition. A second basecoat layer may be applied over at least a portion of the first basecoat layer, wherein the second basecoat layer is formed from a second basecoat composition. The second basecoat layer may be applied after the first basecoat composition has been cured to form the first basecoat layer or may be applied in a wet-on-wet process prior to curing the first basecoat composition, after which the first and second basecoat compositions are simultaneously cured to form the first and second basecoat layers.

At least one of the first and second basecoat compositions may be the coating composition formed from the coating system of the present invention. The first and second basecoat compositions may be the same composition with both the first and second basecoat compositions comprising the coating composition of the present invention. The first and second basecoat compositions may be different with only one of the first and second basecoat compositions comprising the coating composition of the present invention.

The multi-layer coating system may include a primer coating layer formed from a primer composition applied over the substrate. The first basecoat layer may be positioned over at least a portion of the primer coating layer.

The multi-layer coating system may include a topcoat layer formed from a topcoat composition applied over the substrate. The topcoat composition may be applied over at least a portion of the second basecoat layer. The topcoat may be a clearcoat. The clearcoat may be the coating composition formed from the coating system of the present invention.

A substrate having a multi-layer coating system applied thereover may be prepared by applying a first basecoat composition onto at least a portion of the substrate and applying a second basecoat composition directly onto at least a portion of the first basecoat composition. The first and second basecoat compositions may be cured simultaneously to form first and second basecoat layers. At least one of the first and second basecoat compositions may comprise the coating composition formed from the coating system of the present invention.

Preparing the multi-layer coating system may include forming a primer coating layer over at least a portion of the substrate and applying the first basecoat composition onto at least a portion of the primer coating layer.

Preparing the multi-layer coating system may include applying a topcoat composition onto at least a portion of the second basecoat composition. The topcoat composition (e.g., a clearcoat composition) may be applied onto the second basecoat composition prior to or after curing the first and second basecoat compositions. The first basecoat composition, the second basecoat composition, and the topcoat composition may be simultaneously cured. The topcoat composition may comprise the coating composition formed from the coating system of the present invention, while the first and second basecoats are different from the coating composition formed from the coating system of the present invention.

The two-component coating system described herein may be prepared by preparing the first component as described herein and filling a first container therewith. The two-component coating system may be prepared by preparing the second component as described herein and filling a second container different from the first container with the second component. The first container and the second container may be arranged such that the first component and the second component do not contact one another until a user is preparing to apply the coating composition prepared from the coating system to a substrate. To prepare the coating composition from the coating system, the user may contact the first component from the first container with the second component from the second container to form a coating composition, such as by mixing the first component with the second component. The coating composition may be applied over a substrate and cured to form a cured coating layer thereover. The coating composition (the mixture of the first and second components) may be applied over the substrate within 48 hours of first contacting the first component with the second component, such as within 24 hours, within 12 hours, or within 8 hours.

### EXAMPLES

The following examples are presented to demonstrate the general principles of the invention. The invention should not be considered as limited to the specific examples presented. All parts and percentages in the examples are by weight unless otherwise indicated.

### Examples A-F

### Preparation of Acid-Functional Acrylic Polymers

A 300 mL electrically heated continuous stirred-tank reactor with an internal cooling coil was filled with 2-butoxyethanol and the temperature was adjusted to the set temperature from Table 1. The first reactor charge from Table 1 below was fed to the reactor from a feed tank at 60 mL/minute, resulting in a residence time of five minutes. The reactor was kept volumetrically full at a pressure of 200-300 psi. The temperature was held constant at the set temperature. The reactor output was drained to a waste vessel for the first fifteen minutes and was then diverted to a 4000 mL continuous stirred tank reactor fitted with a pressure relief valve set to vent at 35 psi. At this point the second reactor charge was fed to the second reactor at a rate that matched the initiator level. The contents of the second reactor were maintained at a set temperature from Table 1. When 2230 mL of product had been added to the second reactor, the outlet valve was opened and the resin was fed to a collection vessel at a rate that maintained a constant fill level, resulting in a 30 minute residence time. The collected resin was diluted to 35% solids in water with dimethylethanolamine (DMEA) added to match theoretical neutralization % from Table 1.

TABLE 1

| | | Compar- | | | | | |
|---|---|---|---|---|---|---|---|
| | | ative | | | | | |
| | | Polymer | Polymer | Polymer | Polymer | Polymer | Polymer |
| | Component | A | B | C | D | E | F |
| First | Isobornyl | 840 | 616 | 616 | 390 | 360 | 350 |
| reactor | acrylate | | | | | | |
| charge | Butyl | 840 | 700 | 700 | — | — | — |
| (grams) | methacrylate | | | | | | |
| | Methyl | — | — | — | 377 | 228 | 250 |
| | methacrylate | | | | | | |
| | Butyl | 560 | 588 | 588 | 715 | 660 | 600 |
| | acrylate | | | | | | |
| | Styrene | 224 | 280 | 140 | 260 | 240 | 250 |
| | Acrylic acid | 280 | 560 | 700 | 780 | 840 | 1000 |
| | 2- | — | 56 | 56 | 78 | 72 | 50 |
| | hydroxyethyl | | | | | | |
| | methacrylate | | | | | | |
| | α- | 56 | — | — | — | — | — |
| | methylstyrene | | | | | | |
| | dimer | | | | | | |
| | DOWANOL | — | 140 | 140 | 195 | 180 | 250 |
| | DPM¹ | | | | | | |
| | di-t-amyl | — | 28 | 28 | 26 | 24 | 25 |
| | peroxide | | | | | | |
| | di-t-butyl | 56 | — | — | — | — | — |
| | peroxide | | | | | | |
| Second | di-t-amyl | — | 28 | 28 | 26 | 24 | 25 |
| reactor | peroxide | | | | | | |
| charge | di-t-butyl | 28 | — | — | — | — | — |
| (grams) | peroxide | | | | | | |
| Monomer | Isobornyl | 30 | 22 | 22 | 15 | 15 | 14 |
| compo- | acrylate | | | | | | |
| sition | Butyl | 30 | 25 | 25 | — | — | — |
| (weight | methacrylate | | | | | | |
| %) | Methyl | — | — | — | 14.5 | 9.5 | 10 |
| | methacrylate | | | | | | |
| | Butyl | 20 | 21 | 21 | 27.5 | 27.5 | 24 |
| | acrylate | | | | | | |
| | Styrene | 8 | 10 | 5 | 10 | 10 | 10 |
| | Acrylic acid | 10 | 20 | 25 | 30 | 35 | 40 |
| | 2- | — | 2 | 2 | 3 | 3 | 2 |
| | hydroxyethyl | | | | | | |
| | methacrylate | | | | | | |
| | methylstyrene | 2 | — | — | — | — | — |
| | dimer | | | | | | |
| Reactor | First reactor | 210 | 210 | 210 | 220 | 220 | 220 |
| tempera- | Second | 170 | 170 | 170 | 190 | 190 | 190 |
| ture | reactor | | | | | | |
| (° C.) | | | | | | | |
| Initiator | First reactor | 2 | 1 | 1 | 1 | 1 | 1 |
| level | Second | 1 | 1 | 1 | 1 | 1 | 1 |
| (% by | reactor | | | | | | |
| weight | | | | | | | |
| on | | | | | | | |
| monomers) | | | | | | | |
| | Total | 50 | 35 | 30 | 25 | 18 | 17 |
| | Neutralization | | | | | | |
| | % | | | | | | |

¹Dipropylene glycol methyl ether solvent available from Dow Chemical Company (Midland, MI)

The properties of the Polymers A-F are summarized in Table 2. The acid values are reported in mgKOH/g based on resin solids and were determined as previously described. Mn and Mw were determined as previously described. Tg was calculated using the Fox Equation.

TABLE 2

| | Comparative | Polymer | Polymer | Polymer | Polymer | Polymer |
|---|---|---|---|---|---|---|
| | Polymer A | B | C | D | E | F |
| Mw | 4899 | 6421 | 4155 | 5350 | 4664 | 3510 |
| Mn | 1794 | 2293 | 1837 | 1372 | 712 | 943 |
| Polydispersity | 2.7 | 2.8 | 2.3 | 3.9 | 6.6 | 3.7 |
| Acid value | 69.0 | 142.1 | 174.5 | 209.3 | 225.5 | 264.2 |
| Calculated Tg (° C.) | 34.5 | 33.0 | 33.0 | 39.6 | 39.6 | 46.9 |

### Comparative Example G

### Preparation of Acid-Functional Small Molecule

57.7 g citric acid was dissolved in 107.16 g deionized water to form a clear solution.

### Comparative Example H

### Preparation of Acid-Functional Small Molecule

To a four-neck round bottle flask was added 44.7 g trimethylolpropane and 168.19 g methylhexahydrophthalic anhydride. The mixture was heated up to 160° C. gradually. The reaction was monitored through IR. Once the IR peak of anhydride at 1777 cm−1 disappeared, the reaction was cooled to 80° C. A charge of 53.46 g dimethyl ethanol amine and 332.71 g deionized water was added to the flask through an addition funnel to yield the final product as a clear solution.

### Examples 1-8

### Preparation and Evaluation of Acid-Epoxy Coating Compositions Using the Same Epoxy

Various coating compositions were made by mixing the ingredients described in Table 3; all compositions were adjusted to the same acid to epoxy equivalent ratio. Then, the coating compositions were applied using a 8-mil BYK drawdown bar over steel panels pre-coated with electrodeposition primer ED6280Z (available from PPG Industries, Inc. (Pittsburgh, PA)). After flashing at room temperature for 10 minutes, the panels were baked at 127° C. for 30 minutes.

TABLE 3

| | Example | | | | | | | |
|---|---|---|---|---|---|---|---|---|
| Ingredients | Comp. | | | | | | Comp. | Comp. |
| (grams) | 1 | 2 | 3 | 4 | 5 | 6 | 7 | 8 |

A-Pack

| | | | | | | | | |
|---|---|---|---|---|---|---|---|---|
| Acrylic | 51.13 | — | — | — | — | — | — | — |
| from | | | | | | | | |
| Polymer A | | | | | | | | |
| Acrylic | — | 23.72 | — | — | — | — | — | — |
| from | | | | | | | | |
| Polymer B | | | | | | | | |
| Acrylic | — | — | 20.11 | — | — | — | — | — |
| from | | | | | | | | |
| Polymer C | | | | | | | | |
| Acrylic | — | — | — | 16.94 | — | — | — | — |
| from | | | | | | | | |
| Polymer D | | | | | | | | |
| Acrylic | — | — | — | — | 15.55 | — | — | — |
| from | | | | | | | | |
| Polymer E | | | | | | | | |
| Acrylic | — | — | — | — | — | 12.84 | — | — |
| from | | | | | | | | |
| Polymer F | | | | | | | | |
| PE from | — | — | — | — | — | — | 4 | — |
| Example G | | | | | | | | |
| PE from | — | — | — | — | — | — | — | 11.03 |
| Example H | | | | | | | | |

B-Pack

| | | | | | | | | |
|---|---|---|---|---|---|---|---|---|
| Epoxy A² | 2.74 | 2.74 | 2.74 | 2.74 | 2.74 | 2.74 | 2.74 | 2.74 |

²ACHWL CER 4221: a cycloaliphatic epoxy resin available from Achiewell, LLC (North Wales, PA)

After removal from the oven, the panels were stored for 24 hours under ambient conditions and then tested for solvent resistance (methyl ethyl ketone (MEK) double rubs, according to ASTM D5402-15 published on 6-1-2015), with 150 MEK double rubs being the maximum number of rubs tested. Hardness was measured using a Fischer Technologies H100C Micro hardness Measurement System in accordance with ISO 14577-4.2016, with higher hardness values being better. The solvent resistance and hardness properties of the drawdown panels are shown in Table 4.

TABLE 4

| | Example | | | | | | | |
|---|---|---|---|---|---|---|---|---|
| | Comp. | | | | | | Comp. | Comp. |
| Test | 1 | 2 | 3 | 4 | 5 | 6 | 7 | 8 |
| MEK | 10 | 80 | 150 | 150 | 150 | 150 | N/A | N/A |
| to Mar | | | | | | | | |
| Fischer | <50 | 152.3 | 156.6 | 184.0 | 190.1 | 194.6 | N/A | N/A |
| micro | | | | | | | | |
| hardness of | | | | | | | | |
| Cured Film | | | | | | | | |

N/A-The MEK and hardness tests for Comparative Examples 7 and 8 could not be adequately performed as the coating compositions were still wet and did not form a cured film.

As shown in Table 4, the coatings using the acid-functional polymers of the present invention exhibited higher hardness. Moreover, the coatings using the acid-functional polymers of the present invention also exhibited better solvent resistance.

### Examples 9-17

### Preparation and Evaluation of Acid-Epoxy Coating Compositions Using Different Types of Epoxy

Various coating compositions were prepared by mixing the ingredients described in Table 5; all compositions were adjusted to the same acid to epoxy equivalent ratio. Then, the coating compositions were applied using a 5-mil BYK drawdown bar over steel panels pre-coated with electrodeposition ED6100c and powder primer PCV70500 (available from PPG Industries, Inc. (Pittsburgh, PA)). After flashing at room temperature for 10 minutes, the panels were baked at 127° C. for 30 minutes,

TABLE 5

| Ingred- | | | | | | | | | |
|---|---|---|---|---|---|---|---|---|---|
| ients | | | | | | | | | |
| (grams) | 9 | 10 | 11 | 12 | 13 | 14 | 15 | 16 | 17 |
| A-Pack | | | | | | | | | |
| Epoxy A² | 5.5 | — | — | — | — | — | — | — | 6.9 |
| Epoxy B³ | — | 6.7 | — | — | — | — | — | — | — |
| Epoxy C⁴ | — | — | 6.2 | — | — | — | — | — | — |
| Epoxy D⁵ | — | — | — | 5.5 | — | — | — | — | — |
| Epoxy E⁶ | — | — | — | — | 4.0 | — | — | — | — |
| Epoxy F⁷ | — | — | — | — | — | 7.0 | — | — | — |
| Epoxy G⁸ | — | — | — | — | — | — | 8.4 | — | — |
| Epoxy H⁹ | — | — | — | — | — | — | — | 7.5 | — |
| RHODIA- | 1.5 | 1.5 | 1.5 | 1.5 | 1.5 | 4.0 | 4.0 | 4.0 | 1.5 |
| SOLV | | | | | | | | | |
| RPDE¹⁰ | | | | | | | | | |
| COLOUR | — | — | — | — | — | — | — | — | 0.5 |
| BLACK | | | | | | | | | |
| OE | | | | | | | | | |
| 430 W¹¹ | | | | | | | | | |
| BYK-011¹² | — | — | — | — | — | — | — | — | 0.3 |
| B-Pack | | | | | | | | | |
| Acrylic | 29.6 | 29.6 | 29.6 | 29.6 | 29.6 | 29.6 | 29.6 | 29.6 | 37.0 |
| from | | | | | | | | | |
| Polymer E | | | | | | | | | |
| Water | 1.2 | 1.2 | 1.2 | 1.2 | 1.2 | 1.2 | 1.2 | 1.2 | 5 |
| DOWAN- | 1.6 | 1.6 | 1.6 | 1.6 | 1.6 | 1.6 | 1.6 | 1.6 | 2.0 |
| OL | | | | | | | | | |
| PNB¹ | | | | | | | | | |

³ARALDITE CY 184: a low-viscosity cycloaliphatic epoxy available from Huntsman Corporation (The Woodlands, TX)
⁴HELOXY 107: a diglycidyl ether of cyclohexane dimethanol available from Hexion Inc. (Columbus, OH)
⁵EPODIL 749: a neopentyl glycol diglycidyl ether available from Evonik Corporation (Allentown, PA)
⁶ERISYS GE-21: an epoxidized butanediol available from Huntsman Corporation (The Woodlands, TX)
⁷D.E.N. 431 Epoxy Novolac Resin: a semi-solid reaction product of epichlorohydrin and phenol-formaldehyde Novolac available from Dow Chemical Company (Midland, MI)
⁸EPONEX 1510: a medium viscosity hydrogenated DPP epoxy resin available from Hexion Inc. (Columbus, OH)
⁹EPON Resin 828: an undiluted clear difunctional bisphenol A/epichlorohydrin derived liquid epoxy resin available from Hexion Inc. (Columbus, OH)
¹⁰A classical dibasic ester solvent available from Solvay S.A. (Brussels, Belgium)
¹¹A carbon black available from Orion Engineered Carbons (Houston, TX)
¹²A defoamer available from BYK (Wesel, Germany)

The solvent resistance, hardness, and appearance properties of the coatings are shown in Table 6. Gloss (20°) was measured according to ASTM D523. DOI was measured according to ASTM D5767.

TABLE 6

| Test | 9 | 10 | 11 | 12 | 13 | 14 | 15 | 16 | 17 |
|---|---|---|---|---|---|---|---|---|---|
| MEK to | 150 | 100 | 150 | 80 | 150 | 150 | 150 | 150 | 150 |
| Mar | | | | | | | | | |
| Fischer | 153.0 | 132.9 | 105.5 | 104.1 | 78.5 | 158.6 | 121.3 | 150.9 | 157.5 |
| micro | | | | | | | | | |
| hardness | | | | | | | | | |
| Gloss | 83 | 84 | 83 | 70 | 73 | 87 | 86 | 91 | 53 |
| (20°) | | | | | | | | | |
| DOI | 68 | 69 | 60 | 31 | 38 | 81 | 89 | 83 | 67 |

The coating compositions in Examples 9-17 all exhibited good solvent resistance and hardness properties. Certain of the compositions also had high gloss and DOI properties (e.g., Examples 14-16) and may be particularly suitable for use as a high gloss topcoat. Others of the Examples provided a good coating composition based on the solvent resistance and hardness data and may be suitable for use as a low gloss topcoat or as another coating layer in a multi-layer coating system.

### Examples 18-26

### Preparation and Evaluation of Acid-Epoxy Coating Compositions Prepared as One-Component and Two-Component Systems

Representative A and B-packs of a 2-component acid-epoxy formulation were formulated as shown in Table 7. To evaluate the properties of the coating composition as a one-component formulation, the A and B packs were combined at t=0 hours, as shown in Table 8. Samples were taken from the mixture at various time points post mixing (0, 2, 4, 24, 48, and 168 hours) and applied using a 5-mil BYK drawdown bar over steel panels pre-coated with electrodeposition primer ED6280Z (available from PPG Industries, Inc. (Pittsburgh, PA)). The CAP viscosity of the combined formulation was also measured at each time point using a Brookfield CAP 2000 viscometer with #4 spindle at 300 rpm at 23° C. To evaluate the coating composition as a two-component formulation, the A and B packs were combined together in the same ratio as the one-component formulation at t=48 and 168 hours, as shown in Table 8. Immediately following mixing, the coating composition was applied and the viscosity measured in the same manner as the one-component formulation. Post application, all panels were flashed at room temperature for 10 minutes and then baked at 127° C. for 30 minutes.

TABLE 7

| | Example | | |
|---|---|---|---|
| Ingredients (grams) | 18 | 19 | 20 |

B-Pack

| | | | |
|---|---|---|---|
| Acrylic from Polymer E | 592 | — | — |
| Water | 48 | — | — |
| DOWANOL PNB | 32 | — | — |

A-Pack

| | | | |
|---|---|---|---|
| Epoxy A² | — | 110 | — |
| Epoxy H⁹ | — | — | 138.1 |
| RHODIASOLV RPDE¹⁰ | — | 30 | 73.7 |

TABLE 8

| Ingredients | Example | | | | | |
|---|---|---|---|---|---|---|
| (grams) | 21 | 22 | 23 | 24 | 25 | 26 |
| Example 18 | 100.8 | 100.8 | 25.2 | 25.2 | 25.2 | 25.2 |
| Example 19 | 21.0 | — | 5.3 | — | 5.3 | — |
| Example 20 | — | 25.2 | — | 8.6 | — | 8.6 |
| Water | 9.4 | 13.7 | 2.3 | 3.4 | 2.3 | 3.4 |

After removal from the oven, the panels were stored for 24 hours under ambient conditions and then tested for solvent resistance, hardness, gloss, and DOI, as described in previous examples. The properties of each panel are shown in Tables 9 and 10.

Immediately after mixing the A-pack and B-pack (t=0 hour) in Example 21, the coating composition has an acceptable viscosity for application and high gloss, DOI, fisher micro hardness, and solvent resistance. The gloss and DOI of Example 21 reduce significantly when applying the mixture after it sits combined for 24 hours, and the viscosity of the combined formulation more than doubles within 48 hours. If the A-packs and B-packs are treated as a two-component system and mixed together immediately prior to application (Examples 23 and 25), the viscosity, solvent resistance, fisher micro hardness, gloss, and DOI of the coating at t=48 and 168 hours are similar the properties of the coating at t=0 hour.

In Table 10, the viscosity of another A-pack and B-pack combination (Example 22) treated as a one-component formulation increases significantly within 168 hours. The coating composition, when treated as a two-component formulation and mixed immediately prior to application (Examples 24 and 26), has a viscosity, solvent resistance, fisher micro hardness, gloss, and DOI at t=48 and 168 hours similar to the properties at t=0 hour.

TABLE 9

| | Example | | | | | | | |
|---|---|---|---|---|---|---|---|---|
| Property | 21 | 21 | 21 | 21 | 21 | 21 | 23 | 25 |
| Combination | 0 | 0 | 0 | 0 | 0 | 0 | 48 | 168 |
| time (hr) | | | | | | | | |
| Drawdown | 0 | 2 | 4 | 24 | 48 | 168 | 48 | 168 |
| time (hr) | | | | | | | | |
| CAP viscosity | 101 | 99 | 98 | 116 | 210 | —¹³ | 97 | 90 |
| (cP) | | | | | | | | |
| MEK to MAR | 150 | 125 | 125 | 100 | 50 | 50 | 150 | 150 |
| Fisher micro | 184 | 182 | 180 | 176 | 193 | 151 | 183 | 181 |
| hardness | | | | | | | | |
| Gloss (20°) | 84.7 | 76.4 | 53.4 | 18.8 | 27.6 | 1.1 | 87.6 | 86.0 |
| DOI | 87.7 | 76.6 | 53.9 | 29.8 | 34.2 | 7.0 | 86.0 | 79.5 |

¹³Formulation viscosity exceeded viscosity limit for CAP measurement.

TABLE 10

| | Example | | | | | | | |
|---|---|---|---|---|---|---|---|---|
| Property | 22 | 22 | 22 | 22 | 22 | 22 | 24 | 26 |
| Combination | 0 | 0 | 0 | 0 | 0 | 0 | 48 | 168 |
| time (hr) | | | | | | | | |
| Drawdown | 0 | 2 | 4 | 24 | 48 | 168 | 48 | 168 |
| time (hr) | | | | | | | | |
| Cap viscosity | 107 | 109 | 112 | 116 | 129 | —¹⁴ | 110 | 109 |
| (cP) | | | | | | | | |
| MEK to MAR | 150 | 150 | 150 | 150 | 150 | —¹⁴ | 150 | 150 |
| Fisher micro | 174 | 169 | 166 | 161 | 170 | —¹⁴ | 172 | 162 |
| hardness | | | | | | | | |
| Gloss (20°) | 75.8 | 86.3 | 79.0 | 77.8 | 88.9 | —¹⁴ | 93.0 | 93.6 |
| DOI | 70.5 | 78.6 | 76.2 | 64.4 | 88.8 | —¹⁴ | 88.1 | 91.2 |

¹⁴Formulation was a gel, so could not be applied as a film

Whereas particular embodiments of this invention have been described above for purposes of illustration, it will be evident to those skilled in the art that numerous variations of the details of the present invention may be made without departing from the invention as defined in the appended claims.

1. A two-component waterborne coating system, comprising:
a first component comprising an acid-functional polymer having an acid value of at least 100, based on total resin solids, dispersed in an aqueous medium; and
a second component separate from the first component, wherein the second component comprises an epoxy-functional compound.

2. (canceled)

3. The coating system of claim 1, wherein the acid-functional polymer has an acid value of at least 130, based on total resin solids.

4. The coating system of claim 1, wherein the acid-functional polymer has a weight average molecular weight of at least 2,000.

5. The coating system of claim 1, wherein the acid-functional polymer has a Tg of from −40° C. to 80° C.

6. The coating system of claim 1, wherein the acid-functional polymer comprises an acrylic polymer.

7. The coating system of claim 1, wherein the epoxy-functional compound has a weight average molecular weight of up to 2,000.

8. The coating system of claim 1, wherein the epoxy-functional compound comprises a cycloaliphatic epoxy, an aliphatic epoxy, a hexahydrophthalic anhydride-based diester epoxy, a cyclohexane dimethanol-based epoxy, a neopentyl glycol-based epoxy, a polyglycidyl ether epoxy, an aromatic polyfunctional epoxy, a bisphenol-A bisepoxide, a hydrogenated bisphenol-A bisepoxide, a triglycidyl ether of trimethylolpropane, or some combination thereof.

9. The coating system of claim 1, further comprising a neutralizing amine.

10. The coating system of claim 9, further comprising a catalyst different from the neutralizing amine.

11. The coating system of claim 1, further comprising a crosslinker comprising an aminoplast, a blocked isocyanate, a silane, an oxazoline, a carbodiimide, or some combination thereof.

12. The coating system of claim 1, wherein the coating system is substantially free of pigment.

13. The coating system of claim 1, wherein the coating system is substantially free of unreacted isocyanate.

14. The coating system of claim 1, wherein the second component is substantially free of water.

15. The coating system of claim 1, wherein the coating system has a volatile organic content (VOC) below 420 g/L measured excluding water and according to ASTM D3960, based on total volume of the coating system.

16. (canceled)

17. The coating system of claim 1, wherein the ratio of acid groups to epoxy groups in the coating system ranges from 1.5:1 to 1:1.5.

18. (canceled)

19. The coating system of claim 1, wherein the second component further comprises a second epoxy-functional compound.

20. The coating system of claim 19, wherein the second epoxy-functional compound comprises an epoxy-functional acrylic.

21. A substrate at least partially coated with a coating composition formed from the coating system of claim 1.

22. The substrate of claim 21, wherein the substrate comprises a vehicle substrate.

23-29. (canceled)
